(19) United States
(12) Patent Application Publication
(10) Pub. No.: US 2013/0194396 A1
(43) Pub. Date: Aug. 1, 2013

(54) ELECTRONIC APPARATUS, DISPLAY DEVICE AND DISPLAY CONTROL METHOD

(71) Applicant: Hajime SONOBE, Tachikawa-shi (JP)

(72) Inventor: Hajime SONOBE, Tachikawa-shi (JP)

(73) Assignee: KABUSHIKI KAISHA TOSHIBA, Tokyo (JP)

(21) Appl. No.: 13/614,261

(22) Filed: Sep. 13, 2012

(30) Foreign Application Priority Data
Jan. 31, 2012 (JP) 2012-018974

(51) Int. Cl. H04N 13/04

(52) U.S. Cl. 348/51; 348/E13.075

(57) ABSTRACT

According to one embodiment, an electronic apparatus includes an area setting module, a display controller and a 3D function controller. The area setting module outputs a request for displaying a 3D image to a display device via a first interface in order to cause the display device to set a 3D area. The display controller outputs a video signal of the 3D image to the display device via a second interface in order to cause the display device to display the 3D image in the 3D area. The 3D function controller outputs, if abnormality occurs in operation of an OS executed on the electronic apparatus, a signal for disabling a 3D function to the display device via a third interface in order to set an entire screen of the display device to be a 2D area.

### CROSS-REFERENCE TO RELATED APPLICATIONS

This application is based upon and claims the benefit of priority from prior Japanese Patent Application No. 2012-018974, filed Jan. 31, 2012, the entire contents of which are incorporated herein by reference.

### FIELD

Embodiments described herein relate generally to an electronic apparatus and a display device which have a function of displaying a three-dimensional image, and a display control method.

### BACKGROUND

In recent years, there are provided various electronic apparatuses for viewing a three-dimensional (3D) image. An example of such electronic apparatuses is an electronic apparatus including a display unit of an autostereoscopic scheme (naked-eye 3D scheme). In the autostereoscopic scheme, for example, a left-eye image and a right-eye image are displayed on the screen of a liquid crystal display (LCD), and the directions of emission of light rays corresponding to the pixels in these images are controlled by a parallax barrier or a lenticular lens, which is disposed on the LCD.

On the screen of the LCD, the pixels included in the left-eye image and the pixels included in the right-eye image are arranged in a predetermined order. For example, the pixels included in the left-eye image and the pixels included in the right-eye image are alternately arranged on the screen. The barrier (lens) on the LCD controls the directions of emission of light rays corresponding to the arranged pixels. Thereby, a user can view the pixels of the left-eye image by the left eye and the pixels of the right-eye image by the right eye, thus being able to perceive a 3D image (stereoscopic image).

In the meantime, as the barrier or lens, there is known an active barrier or an active lens, which has a function of electrically switching (on/off) the function for displaying a 3D image in each of a plurality of areas provided in the screen. In such an active barrier or active lens, an arbitrary area provided in the screen can be set to be either an area where a 3D image is displayed or an area where a two-dimensional (2D) image is displayed. Meanwhile, from the standpoint of cost reduction, there is known an active barrier or active lens, which has only a switching function of the entire area of the active barrier or active lens.

A display driver, which is executed on the electronic apparatus, outputs to the display unit a command for switching the above-described active barrier (active lens), responding to a request by an operating system (OS) or various programs. However, for example, when the OS hangs, it becomes impossible to control the display unit via the display driver.

In addition, in some cases, when the OS hangs, a screen of a 2D image (hang-up screen) is displayed for notifying abnormality in operation of the OS. On this screen, for example, the user is notified of information relating to the current state of the OS, or information for dealing with the current state of the OS. However, when the LCD and the active barrier have been set to display a 3D image (3D image display function “ON”), it is difficult for the user to read, e.g. characters which are displayed on the screen of a 2D image for notifying abnormality.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an electronic apparatus according to an embodiment.

FIG. 2 is an exemplary block diagram illustrating a configuration example of the electronic apparatus of the embodiment.

FIG. 3 is an exemplary view illustrating a structure example of a screen which is displayed by the electronic apparatus of the embodiment.

FIG. 4 is an exemplary block diagram for describing a structure for displaying a 2D image and a 3D image, which is provided in the electronic apparatus of the embodiment.

FIG. 5 is an exemplary block diagram illustrating the configuration of a timing controller which is provided in a display unit in the electronic apparatus of the embodiment.

FIG. 6 is an exemplary flowchart illustrating an example of the procedure of a 3D image display control process which is executed by the electronic apparatus of the embodiment.

FIG. 7 is an exemplary flowchart illustrating an example of the procedure of a 3D image display termination process which is executed by the electronic apparatus of the embodiment.

FIG. 8 is an exemplary flowchart illustrating an example of the procedure of a 3D area change control process which is executed by the electronic apparatus of the embodiment.

FIG. 9 is an exemplary flowchart illustrating an example of the procedure of an abnormality-time control process which is executed by the electronic apparatus of the embodiment.

FIG. 10 is an exemplary block diagram for describing another structure for displaying a 2D image and a 3D image, which is provided in the electronic apparatus of the embodiment.

### DETAILED DESCRIPTION

Various embodiments will be described hereinafter with reference to the accompanying drawings.

In general, according to one embodiment, an electronic apparatus, which is connected to a display device configured to be capable of displaying a three-dimensional image, includes an area setting module, a display controller and a three-dimensional function controller. The area setting module is configured to output a request for displaying the three-dimensional image to the display device via a first interface in order to cause the display device to set a three-dimensional area which displays the three-dimensional image. The display controller is configured to output a video signal for displaying the three-dimensional image to the display device via a second interface in order to cause the display device to display the three-dimensional image in the three-dimensional area. The three-dimensional function controller is configured to output, if abnormality occurs in operation of an operating system executed on the electronic apparatus, a control signal for disabling a function of displaying the three-dimensional image to the display device via a third interface in order to set an entire screen of the display device to be a two-dimensional area which displays a two-dimensional image.

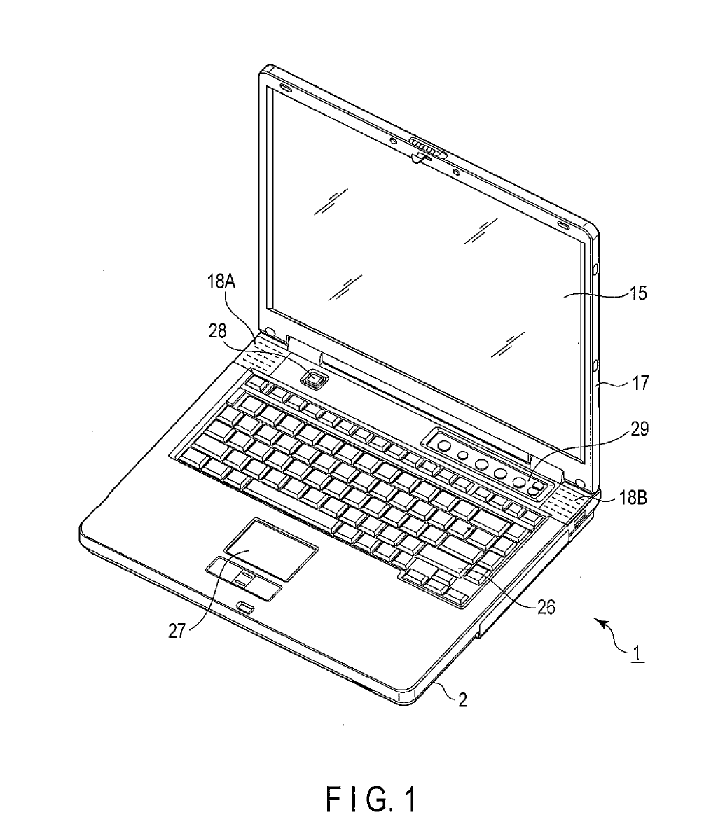

FIG. 1 is a perspective view showing the external appearance of an electronic apparatus according to an embodiment. The electronic apparatus is realized, for example, as a notebook-type personal computer 1. In addition, this electronic apparatus may be realized as a tablet PC, a slate PC, a PDA, a smartphone, or a television receiver.

As shown in FIG. 1, the computer 1 includes a computer main body 2 and a display unit (display device) 17.

A three-dimensional display (3D display) 15 is built in the display unit 17. The display unit 17 is attached to the computer main body 2 such that the display unit 17 is rotatable between an open position where the top surface of the computer main body 2 is exposed, and a closed position where the top surface of the computer main body 2 is covered. In addition, the 3D display 15 includes a liquid crystal display (LCD) layer and an active barrier layer. The active barrier layer is attached on the LCD layer. The active barrier layer includes a plurality of barrier (parallax barrier) mechanisms for emitting, in predetermined directions, a plurality of light rays corresponding to a plurality of pixels included in an image (video frame) displayed on the LCD layer. The active barrier layer is, for example, a barrier which can electrically switch the function that is necessary for three-dimensional (3D) image display. Since this barrier can be switched in accordance with areas on the screen, it is possible to display, for example, a 3D image in an area designated in the screen, and a 2D image in other areas. Specifically, the barrier is turned on in the area which displays a 3D image, and the barrier is turned off in the area which displays a 2D image. Thereby, a three-dimensional area (3D area) for displaying a 3D image and a two-dimensional area (2D area) for displaying a 2D image can be partly switched within the screen. In the 3D area, the barrier is set in an ON state so that a left-eye image and a right-eye image, which are displayed in the 3D area, have a parallax corresponding to an eye separation distance or a viewing distance. In the 2D area, the barrier is set in an OFF state so that a 2D image, which is displayed in the 2D area, is displayed as is. In the 3D display 15, each of the plural areas with arbitrary positions and sizes, which are set in the screen, can be set to be either a 3D area or a 2D area.

Incidentally, the active barrier layer may be replaced with an active lens layer which can electrically switch the function that is necessary for 3D image display. The active lens layer is composed of, for example, a liquid crystal gradient index (GRIN) lens. In the liquid crystal GRIN lens, a refractive index distribution is created by electrodes with use of a planar liquid crystal layer. Thus, a 3D image can be displayed in an area designated in the screen, and a 2D image can be displayed in another area. Specifically, by varying the refractive index of the lens between the area that displays a 3D image and the area that displays a 2D image, the 3D area for displaying a 3D image and the 2D area for displaying a 2D image can be partly switched within the screen. In the 3D area, the refractive index is varied so that a left-eye image and a right-eye image, which are displayed in the 3D area, have a parallax corresponding to an eye separation distance or a viewing distance. In the 2D area, the refractive index is varied so that a 2D image, which is displayed in the 2D area, is displayed as is, without being refracted.

In the 3D display 15, the 3D area displays a left-eye image and a right-eye image, and the 2D area displays a 2D image. Thus, the user can perceive a 3D image when viewing the 3D area in the screen, and can perceive the 2D image when viewing the 2D area. In the meantime, the 3D display 15 may have a function of switching, not an area set in the screen, but the entire screen, to either a 2D area or a 3D area. In this case, the above-described active barrier (or active lens) can electrically switch the ON/OFF of the barrier (lens), for example, with respect to only the entire area of the screen.

The computer main body 2 has a thin box-shaped housing. A keyboard 26, a power button 28 for powering on/off the computer 1, an input operation panel 29, a touch pad 27 and speakers 18A and 18B are disposed on the top surface of the housing of the computer main body 2. Various operation buttons are provided on the input operation panel 29. The buttons include a 3D button for turning on/off a three-dimensional image display function (hereinafter also referred to as “3D display function”).

An external display connection terminal supporting, e.g. the high-definition multimedia interface (HDMI) standard is provided, for example, on a rear surface of the computer main body 2. This external display connection terminal is used for outputting image data (moving picture data) included in video content data, such as broadcast program data, to an external display.

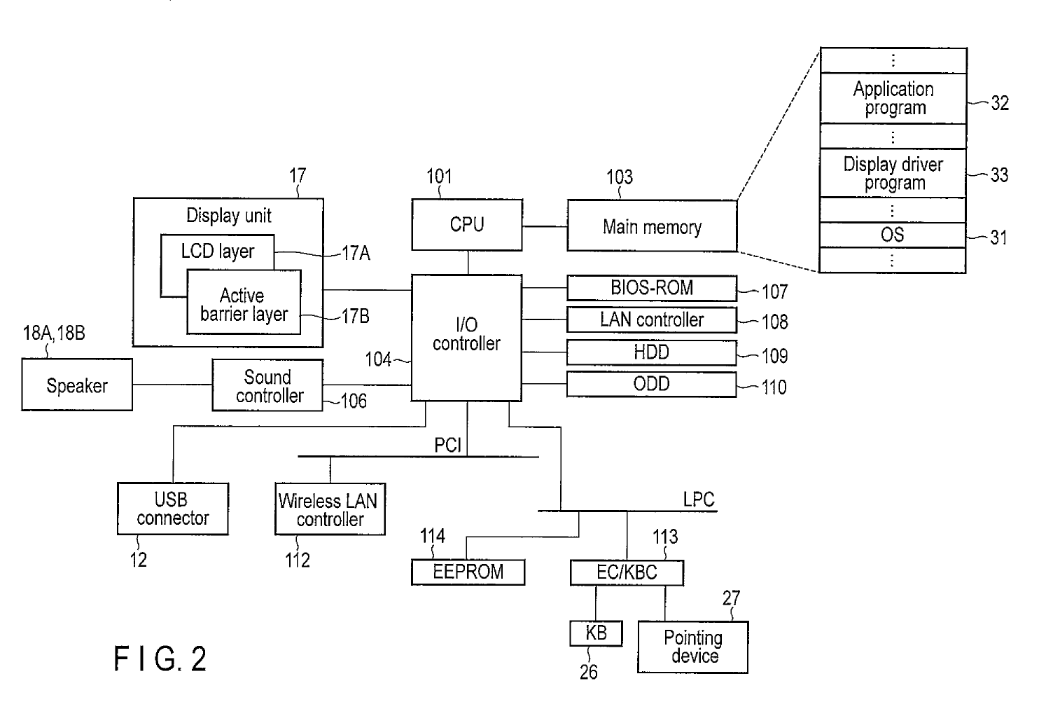

FIG. 2 shows the system configuration of the computer 1.

The computer 1, as shown in FIG. 2, includes a CPU 101, a main memory 103, an I/O controller 104, a display unit 17, a sound controller 106, speakers 18A and 18B, a BIOS-ROM 107, a LAN controller 108, a hard disk drive (HDD) 109, an optical disc drive (ODD) 110, a wireless LAN controller 112, an embedded controller/keyboard controller (EC/KBC) 113, a keyboard (KB) 26, and a pointing device 27.

The CPU 101 is a processor for controlling the operation of the computer 1. The CPU 101 executes an operating system (OS) 31, an application program 32 and a display driver program 33, which are loaded from the HDD 109 into the main memory 103. The application program 32 is software including, for example, a function for viewing video content data, which is executed on the OS 31. The application program 32 executes a live playback process for viewing broadcast program data which is received by a TV tuner, a recording process for recording the received broadcast program data in the HDD 109, a playback process for playing back broadcast program data/video data which is recorded in the HDD 109, and a playback process for playing back video content data which is received via a network. The application program 32 can also play back video content data stored in storage media such as a DVD or a Blu-ray® disc, or in a storage device such as the HDD 109.

Further, the application program 32 includes a function for viewing a 3D image. For the display of a 3D image, use is made of the 3D display 15 by an autostereoscopic scheme (e.g. an integral imaging scheme, a lenticular scheme, or a parallax barrier scheme). The user can perceive a 3D image by the naked eyes by viewing an image which is displayed on the 3D display 15 of the autostereoscopic scheme.

The display driver program 33 is a program for controlling the display unit 17 via the I/O controller 104, in response to a request by the OS 31 or various programs. The display driver program 33 is also called “display driver”. The display driver program 33 issues a command corresponding to the request to the display unit 17, and receives a response from the display unit 17 which has executed a process corresponding to the command. Specifically, the display driver program 33 can execute, via the I/O controller 104, an output of display image data to the display unit 17, data read/write from/to a register provided in the display unit 17, control of power supply to the display unit 17, and control of a backlight provided in the display unit 17.

Besides, the CPU 101 executes a Basic Input/Output System (BIOS) stored in the BIOS-ROM 107. The BIOS (hereinafter also referred to as “system BIOS”) is a program for hardware control. The BIOS includes, for example, a function of controlling the display unit 17.

The CPU 101 includes a memory controller which access-controls the main memory 103.

The I/O controller 104 controls devices on a peripheral component interconnect (PCI) bus and devices on a low pin count (LPC) bus. In addition, the I/O controller 104 controls the display unit 17 which is used as a display of the computer 1. A display signal, which is generated by the I/O controller 104, is sent to the display unit 17. The display unit 17 displays an image, based on the display signal.

Besides, the I/O controller 104 includes an integrated drive electronics (IDE) controller for controlling the HDD 109 and ODD 110, and a memory controller which access-controls the BIOS-ROM 107. The I/O controller 104 also has a function of communicating with the sound controller 106 and LAN controller 108.

Furthermore, the I/O controller 104 can output to the display unit 17 a control signal for executing such control as to set each of a plurality of areas in the screen of the display unit 17 to be either a 3D area or a 2D area, in response to, e.g. a request from the display driver program 33 (application program 32). In the LCD layer 17A and active barrier layer 17B, each of the plural areas is set to be either a 3D area or a 2D area, in accordance with the control signal which has been output by the I/O controller 104. In the meantime, the I/O controller 104 is also called “platform controller hub (PCH)”.

The sound controller 106 is a sound source device and outputs audio data, which is a target of playback, to the speakers 18A and 18B. The LAN controller 108 is a wired communication device which executes wired communication of, e.g. the Ethernet® standard. The wireless LAN controller 112 is a wireless communication device which executes wireless communication of, e.g. the IEEE 802.11 standard. In addition, a USB controller, which is included in the I/O controller 104, communicates with an external device via a cable of, e.g. the USB 2.0 standard, which is connected to a USB connector 13.

The EC/KBC 113 is a one-chip microcomputer in which an embedded controller for power management and a keyboard controller for controlling the keyboard (KB) 26 and pointing device 27 are integrated. The EC/KBC 113 has a function of powering on/off the computer 1 in accordance with the user's operation. The EC/KBC 113 also has a function of disabling (or enabling) the function for displaying a 3D image on the display unit 17, in cooperation with the system BIOS 34. The EC/KBC 113 and system BIOS 34 output to the display unit 17 a control signal for disabling the function for displaying a 3D image, for example, in response to the pressing for a predetermined period (e.g. two seconds) of a predetermined button, such as the power button 28 or a 3D button which is disposed on the input operation panel 29.

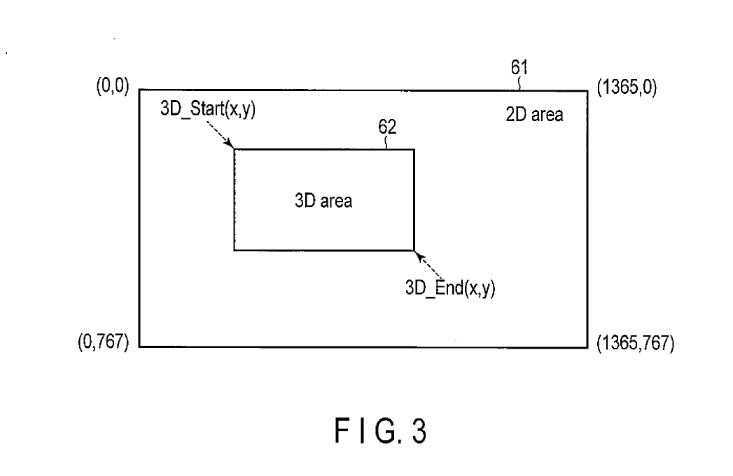

FIG. 3 illustrates a structure example of a screen which is displayed on the display unit 17. This screen has a resolution of, e.g. 1366 pixels×768 pixels. As described above, a 3D area and a 2D area can be set in the screen. In the example illustrated in FIG. 3, a 2D area 61 and a 3D area 62 are set in the screen. The 3D area 62 is designated by, e.g. start coordinates 3D_Start (x, y) and end coordinates 3D_End (x, y) of the area. The 2D area 61 is the area excluding the 3D area 62 in the screen. In the display unit 17, it is also possible to set the entire screen to be the 2D area 61, or to set the entire screen to be the 3D area 62.

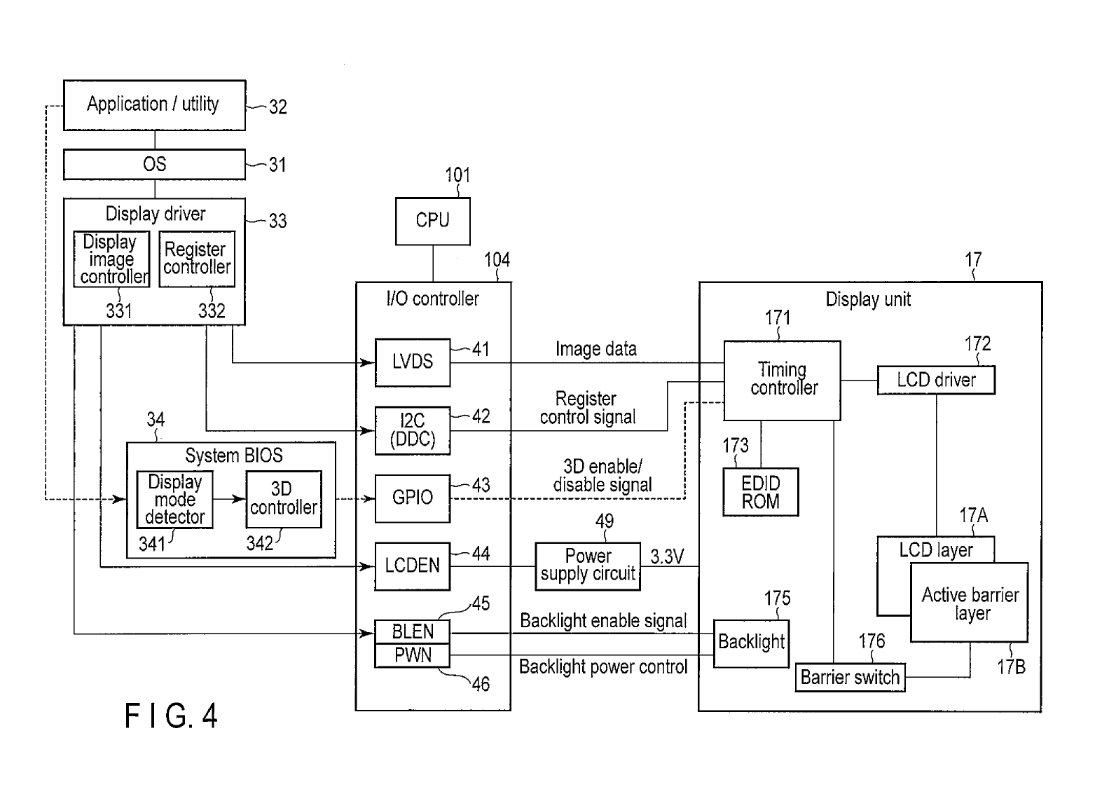

Next, referring to FIG. 4, a description is given of a display control function for controlling display of a 2D image and a 3D image. This display control function enables display of a 2D image, display of a 3D image, and simultaneous display of a 2D image and a 3D image, on the display unit 17. Furthermore, this display control function can disable a 3D image display function if the display unit 17 cannot be controlled via the display driver 33 due to the occurrence of abnormality in operation of the OS 31. This display control function is realized by, for example, the application program (utility program) 32, OS 31, display driver program 33, system BIOS 34, I/O controller 104, and display unit 17.

As described above, the display driver 33 controls the display unit 17, responding to a request by the application program 32 executed on the OS 31. The display driver 33 controls the display unit 17 by outputting various signals to the display unit 17 via the I/O controller 104. The display driver 33 includes a display image controller 331 and a register controller 332.

The system BIOS 34 includes a function of enabling/disabling the 3D image display function of the display unit 17. The system BIOS 34 outputs a control signal (3D enable signal) for enabling the 3D image display function, or a control signal (3D disable signal) for disabling the 3D image display function, to the display unit 17 via the I/O controller 104, thereby enabling/disabling the 3D image display function of the display unit 17. The system BIOS 34 includes a display mode detector 341 and a 3D controller 342.

The I/O controller 104 is provided with various interfaces for inputting/outputting (communicating) various signals from/to the display unit 17. Signal lines and power lines corresponding to communication (transfer) in the respective interfaces are provided between these interfaces and the display unit. The I/O controller 104 is provided with, for example, interfaces between a board provided in the display unit 17 of the autostereoscopic method and a board provided in the computer main body 2. The I/O controller 104 includes, for example, a low voltage differential signaling (LVDS) interface 41, an inter-integrated circuit (I2C) interface 42 for a display data channel (DDC), a general purpose input/output (GPIO) interface 43, an LCD enable (LCDEN) interface 44, a backlight enable (BLEN) interface 45, and a power management (PWM) interface 46 for a backlight 175.

The LVDS interface 41 is an interface for outputting display image data from the computer main body 2 to the display unit 17, responding to a request by the display driver 33.

The I2C interface 42 is an interface for executing data write to a register provided in the display unit 17 or data read from the register, responding to a request by the display driver 33 (or system BIOS 34). For example, a parameter for controlling 3D image display is stored in this register. Specifically, the display unit 17 controls the 3D image display function, based on the parameter written in the register. Since the I2C interface 42 is an interface which is provided in a general LCD as a standard interface, the write of the parameter in the register can be realized at a low cost (low price).

The GPIO interface 43 is an interface for outputting to the display 17 a 3D enable signal for enabling the 3D image display function of the display 17 or a 3D disable signal for disabling the 3D image display function, responding to a request by the system BIOS 34. For example, when an abnormal state of the OS 31, such as hang-up, has occurred, and a register access via the OS 31 and the I2C 42 is disabled, the GPIO interface 43 is used in order to forcibly disable the 3D image display function of the display unit 17.

The LCDEN interface 44 is an interface for outputting to the power supply circuit 49 a signal for turning on/off the power supply to the display 17, responding to a request by the display driver 33. The power supply circuit 49 supplies power (e.g. power of 3.3 V) to the display unit 17, responding to a signal which turns on power supply and is output via the LCDEN interface 44. In addition, the power supply circuit 49 turns off power supply to the display unit 17, responding to a signal which turns off power supply and is output via the LCDEN interface 44. The BLEN interface 45 is an interface for outputting to the display unit 17 a signal for enabling/disabling the backlight 175 provided in the display unit 17, responding to a request by the display driver 33. Besides, the PWM interface 46 is an interface for controlling power which is supplied to the backlight 175, responding to a request by the display driver 33. Specifically, the display driver 33 can control, e.g. the amount of light that is emitted by the backlight 175, via the BLEN interface 45 and PWM interface 46.

In some cases, a control signal for controlling 3D image display is transmitted via a universal serial bus (USB) between the computer main body 1 and the display unit 17. However, the transmission via the USB requires a high cost, since it is necessary to provide the display unit 17 with a USB controller (i.e. to provide a dedicated IC including a USB controller), and to prepare USB driver software. In addition, in the case of the USB, when the OS 31 hangs, the display unit 17 cannot be controlled by the BIOS 34, so the convenience for the user is low. In the present embodiment, as described above, the convenience for the user can be enhanced by controlling the 3D image display by using the I2C 42, and by controlling the display unit 17 by using the GPIO 43 even at the time of hang-up of the OS 31.

Next, the display unit 17 includes the LCD layer 17A, the active barrier layer 17B, a timing controller (T-Con) 171, an LCD driver 172, an EDID ROM 173, a backlight 175, and a barrier switch 176. As described above, the LCD layer 17A is a layer of the liquid crystal display for displaying an image. In addition, the active barrier layer 17B is a layer including a plurality of barriers for emitting, in predetermined directions, a plurality of light rays corresponding to a plurality of pixels included in an image displayed on the LCD layer 17A.

Extended display identification data (EDID) is stored in the EDID ROM 173. The EDID is used, for example, in order for the system BIOS 34 to identify the display unit 17. When a 3D image is displayed, right-eye pixels and left-eye pixels are arranged in a predetermined pattern on the LCD layer 17A.

When the 3D image display function is enabled, the timing controller 171 executes a predetermined process on display image data, and outputs the resultant display image data to the LCD driver 172. This predetermined process includes a process of altering the arrangement of pixels corresponding to the 3D area 62. In addition, when the 3D image display function is disabled, the timing controller 171 outputs the display image data to the LCD driver 172 as is. Using the video signal output from the timing controller 171, the LCD driver 172 displays an image (video frame) on the LCD layer 17A.

When the 3D image display function is enabled, the barrier switch 176 electrically switches a plurality of barriers included in the active barrier layer 17B, based on the coordinates indicative of the 3D area 62, which are output by the timing controller 171. Concretely, the barrier switch 176 sets the barriers corresponding to the 3D area 62 in the ON state, and sets the barriers corresponding to the 2D area 61 in the OFF state. Specifically, the active barrier layer 17B is configured such that the right-eye pixels displayed on the LCD layer 17A are perceived by the right eye and the left-eye pixels displayed on the LCD layer 17A are perceived by the left eye. Accordingly, by perceiving light rays which are displayed on the LCD layer 17A and have passed through the active barrier layer 17B, the user can view a 3D image in the 3D area 62 and a 2D image in the 2D area 61. In addition, the backlight 175 emits light on the back side or lateral side of the LCD layer 17A, and can control the amount of light of the screen.

Next, the operation of controlling the three-dimensional display function (3D display function) by the above-described structure is concretely described.

To begin with, the display image controller 331 of the display driver 33 receives image data which has been output by the OS 31 (i.e. which has been output by the application 32 via the OS 31). The image data is a video signal including a video signal for displaying a 2D image and a video signal for displaying a 3D image. The display image controller 331 outputs the received image data to the timing controller 171 via the LVDS 41 (second interface). In the meantime, the display image controller 331 may execute a predetermined process on the received image data to generate a display video signal which is to be output to the display unit 17, and may output the generated display video signal to the timing controller 171.

The register controller 332 of the display driver 33 receives a request for displaying a 3D image which has been output by the OS 31 (i.e. which has been output by the application 32 via the OS 31). This request includes, for example, coordinates indicative of the area (3D area) 62 for displaying a 3D image. The register controller 332 outputs this request for displaying a 3D image to the timing controller 171 via the I2C 42 (first interface). Specifically, the register controller 332 outputs the coordinates indicative of the 3D area 62 to the timing controller 171 via the I2C 42 (first interface). In the meantime, the register controller 332 can output coordinates indicative of the 2D area 61, and can output coordinates indicative of the 2D area 61 and coordinates indicative of the 3D area 62. Furthermore, the register controller 332 can output a request for displaying a 2D image on the entire screen, and a request for displaying a 3D image on the entire screen.

The display mode detector 341 of the system BIOS 34 detects abnormality in operation of the OS 31 (e.g. hang-up of OS 31). The display mode detector 341 detects abnormality in operation of the OS 31, for example, by hooking the display mode requested by the OS 31 and detecting that a screen for notifying abnormality in operation of the OS 31 (e.g. a Blue Screen displayed at a time of an operational error of the Windows®) is displayed on the LCD layer 17A. In general, this screen is a screen of a 2D image which notifies information relating to the current state of the OS and information for dealing with the current state of the OS. Thus, when the display unit 17 is set to display a 3D image, the user has difficulty in reading characters (text), etc. displayed on this screen. In addition, at the time of abnormality in operation of the OS 31, the display unit 17 cannot be controlled via the display driver 33. Thus, for example, the 3D image display function cannot be turned off by the user's operation of the application program 32.

Taking this into account, in the present embodiment, the GPIO 43 is provided in the I/O controller 104. When abnormality in operation of the OS 31 has been detected by the display mode detector 341, the 3D controller 342 outputs a 3D disable signal for turning off the 3D image display function of the display unit 17 to the timing controller 171 via the GPIO 43 (third interface). Meanwhile, when no abnormality in operation of the OS 31 has been detected by the display mode detector 341, the 3D controller 342 outputs a 3D enable signal for turning on the 3D image display function of the display unit 17 to the timing controller 171 via the GPIO 43. Specifically, while the OS 31 is normally running, the 3D enable signal is being output to the timing controller 171.

When the 3D enable signal is being output by the 3D controller 342, the timing controller 171 sets the 3D area 62, based on the request for displaying a 3D image, which has been output by the register controller 332, and executes control to display an image by using the display image data which has been output by the display image controller 331. To be more specific, when the 3D enable signal is being output by the 3D controller 342, the timing controller 171 sets, based on the coordinates that are output by the register controller 332, an area indicated by these coordinates to be the 3D area 62, and sets an area excluding the 3D area 62 to be the 2D area 61, thereby executing control to display an image by using the display image data which has been output by the display image controller 332. In the meantime, the timing controller 171 can execute control to selectively display a 2D image or a 3D image on the entire screen, based on a request for displaying a 2D image on the entire screen or a request for displaying a 3D image on the entire screen. In addition, when the 3D disable signal is being output by the 3D controller 342, the timing controller 171 sets the entire screen to be the 2D area 61, and executes control to display an image by using the display image data which has been output by the display image controller 332.

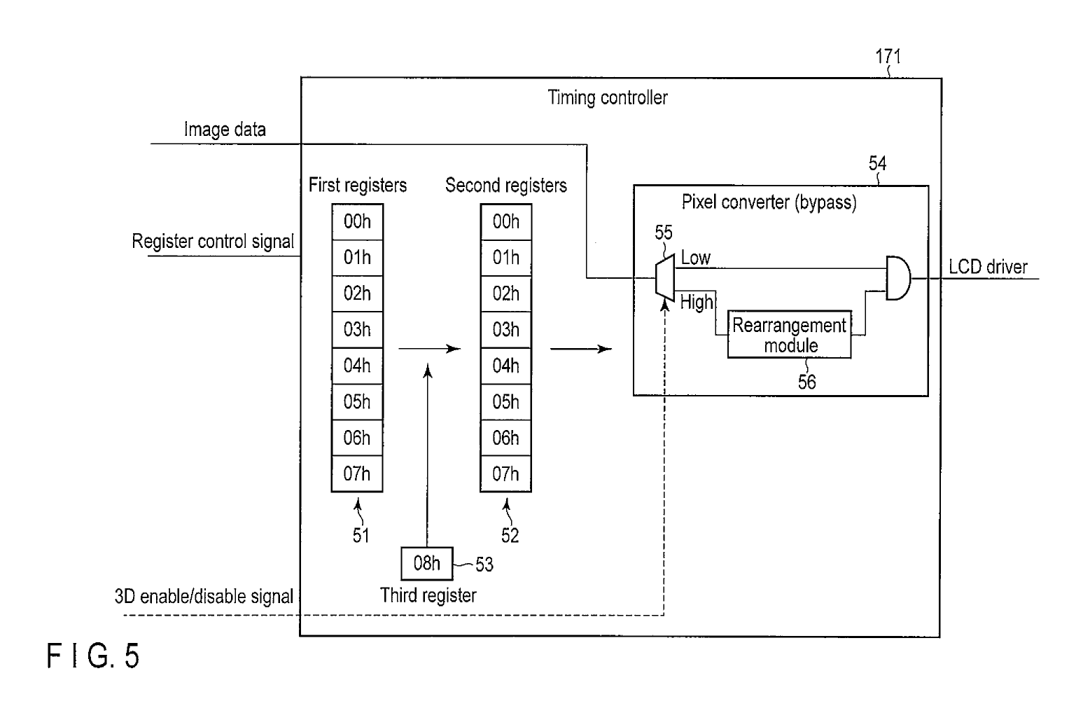

FIG. 5 shows a structure example of the timing controller 171. The timing controller 171 includes, for example, first registers 51, second registers 52, a third register 53, and a pixel converter 54.

The first registers (00h-07h) 51 are registers in which values indicative of coordinates of the 3D area 62, which is set in the screen, are written. Values are written in the first registers 51 via the I2C 42 by the display driver 33. The second registers (00h-07h) 52 are shadow registers of the first registers 51. Values written in the second registers 52 are used for setting the 3D area 62 in the display unit 17. The third register 53 is a register in which a parameter for controlling the 3D image display function of the display unit 17 is written. For example, a value (e.g. “1”), which indicates that a process of writing values indicative of the coordinates of the 3D area 62 has been completed, is written in the 0th bit of the third register 53. A value (e.g. “1”) for activating the pixel converter 54, or a value (e.g. “0”) for stopping the pixel converter 54, is written in the first bit of the third register 53. In addition, a value (e.g. “1”) for setting the active barrier 17B in the ON state, or a value (e.g. “0”) for setting the active barrier 17B in the OFF state, is written in the second bit of the third register 53.

Since the communication speed of the I2C 42 is lower than, for example, the communication speed of a USB, there is a case where the I2C 42 requires a long time period when values are written in a plurality of registers. Thus, for example, even when write to the register 00h of the first registers 51 has been completed, it may be assumed that write to the register 07h has not yet been completed. If the first registers 51 are referred to in this state, it is possible that the coordinates of the 3D area 62 are set to be unintended coordinates and an image (2D image and 3D image) fails to be properly displayed.

Thus, responding to the completion of write of a predetermined value (e.g. “1”) in the 0th bit of the third register 53, the values written in the first registers 51 are reflected (copied) into the second registers (00h-07h). Thereby, even in the case of low-speed communication via the low-speed I2C 42, all of the second registers 52 are updated at a time, and it is possible to prevent the 3D area 62 from being set at unintended coordinates. For example, values indicative of start coordinates (3D_Start (x, y)) of the 3D area 62 shown in FIG. 3 and values indicative of end coordinates 3D_End (x, y) are written in the first registers 51 and second registers 52.

In other words, the register controller 332 of the display driver 33 writes the coordinates indicative of the 3D area 62 in the first registers 51 via the I2C 42. Responding to the completion of the write, the register controller 332 writes a predetermined value (“1”) in the third register 53, thereby reflecting the values written in the first registers 51 into the second registers 52. For example, during a blank period after the write of the predetermined value (“1”) in the third register 53 and the completion of the update of the current image that is displayed on the LCD layer 17A and before the start of update for displaying the next image, the timing controller 171 reflects the values written in the first registers 51 into the second registers 52. The values stored in the second registers 52 are updated each time the predetermined value (“1”) is written in the third register 53. Accordingly, the position and size of the 3D area 62 can be altered by updating the values which are written in the first registers 51 and are reflected from the first registers 51 into the second registers 52.

The pixel converter 54 operates based on the values written in the second registers 52 and third register 53, when the 3D enable signal has been received via the GPIO 43. On the other hand, when the 3D disable signal has been received via the GPIO 43, the pixel converter 54 resets (zero clear) the values written in the registers 51, 52 and 53, and bypasses the display image data which has been received via the LVDS 41.

To be more specific, the pixel converter 54 includes a determination module 55 and a rearrangement module 56. The determination module 55 outputs the display image data to the rearrangement module 56 when the 3D enable signal is received via the GPIO 43 (i.e. when the signal that is output to the determination module 55 via the GPIO 43 is “High”) and the value (e.g. “1”) for activating the pixel converter 54 is set in the first bit of the third register 53. Based on the coordinates indicative of the 3D area 62, which are written in the second registers 52, the rearrangement module 56 detects pixels corresponding to the 3D area 62, among the pixels included in the image based on the display image data. The rearrangement module 56 rearranges the detected pixels (i.e. alters the arrangement of the pixels corresponding to the 3D area 62). The rearrangement module 56 then outputs the image (video signal) including the rearranged pixels to the LCD driver 172. The LCD driver 172 controls displaying the image, which has been output by the rearrangement module 56, on the LCD layer 17A.

When the 3D enable signal is received via the GPIO 43 and the value (e.g. “0”) for stopping the pixel converter 54 is set in the first bit of the third register 53, the determination module 55 bypasses the display image data, thereby outputting the display image data to the LCD driver 172 as is. When the 3D disable signal is received via the GPIO 43 (i.e. when the signal that is output to the determination module 55 via the GPIO 43 is “Low”), the determination module 55 bypasses the display image data, thereby outputting the display image data to the LCD driver 172 as is. The LCD driver 172 controls displaying the image on the LCD layer 17A based on the bypassed display image data.

When the 3D enable signal is received via the GPIO 43 (i.e. when the signal that is output to the determination module 55 via the GPIO 43 is “High”) and the value (e.g. “1”) for turning on the active barrier 17B is set in the second bit of the third register 53, the barrier switch 176 electrically switches each of the plural barriers in the active barrier layer 17B, based on the coordinates indicative of the 3D area 62 which are written in the second registers 52. The barrier switch 176 sets the barrier corresponding to the 3D area 62 in the ON state and sets the barrier corresponding to the 2D area 61 in the OFF state. Accordingly, by the LCD driver 172 and barrier switch 176, a 2D image is displayed in the 2D area 61 and a 3D image is displayed in the 3D area 62.

When the 3D enable signal is received via the GPIO 43 (i.e. when the signal that is output to the determination module 55 via the GPIO 43 is “High”) and the value (e.g. “0”) for turning off the active barrier 17B is set in the second bit of the third register 53, the barrier switch 176 sets all the plural barriers in the active barrier layer 17B in the OFF state. In addition, when the 3D disable signal is received via the GPIO 43 (i.e. when the signal that is output to the determination module 55 via the GPIO 43 is “Low”), the barrier switch 176 sets all the plural barriers in the active barrier layer 17B in the OFF state. In other words, the barrier switch 176 sets the entire screen of the display unit 17 to be the 2D area 61. Accordingly, by the LCD driver 172 and barrier switch 176, a 2D image is displayed in the 2D area 61 set on the entire screen.

As described above, when the 3D enable signal has been received via the GPIO 43, the on/off control of the 3D image display function can be executed in accordance with the values stored in the register. On the other hand, when the 3D disable signal has been received via the GPIO 43, the 3D image display function can be turned off, regardless of the values stored in the register. Accordingly, when the display mode detector 341 of the system BIOS 34 has detected operational abnormality of the OS 31 and the 3D controller 342 has output the 3D disable signal to the timing controller 171 via the GPIO 43, the 3D image display function can be forcibly turned off. Thereby, at the time of operational abnormality of the OS 31, it becomes possible to properly display, on the display which can display a 3D image, a screen of a 2D image which notifies information relating to the current state of the OS 31 and information for dealing with the current state of the OS 31.

The EC/KBC 113 may have a function of detecting that a predetermined button, such as the power button 28 or a 3D button which is disposed on the input operation panel 29, has been pressed for a predetermined period (e.g. two seconds) or more. Responding to the detection by the EC/KBC 113 of the pressing of the predetermined button for the predetermined period or more, the 3D controller 342 of the system BIOS 34 outputs to the timing controller 171 the control signal (3D disable signal) for disabling the function for displaying a 3D image. The timing controller 171 disables the function for displaying a 3D image in accordance with this control signal, and sets the entire screen to be the 2D area. Thereby, since the user can execute the operation for turning off the 3D image display function, the convenience for the user can be enhanced.

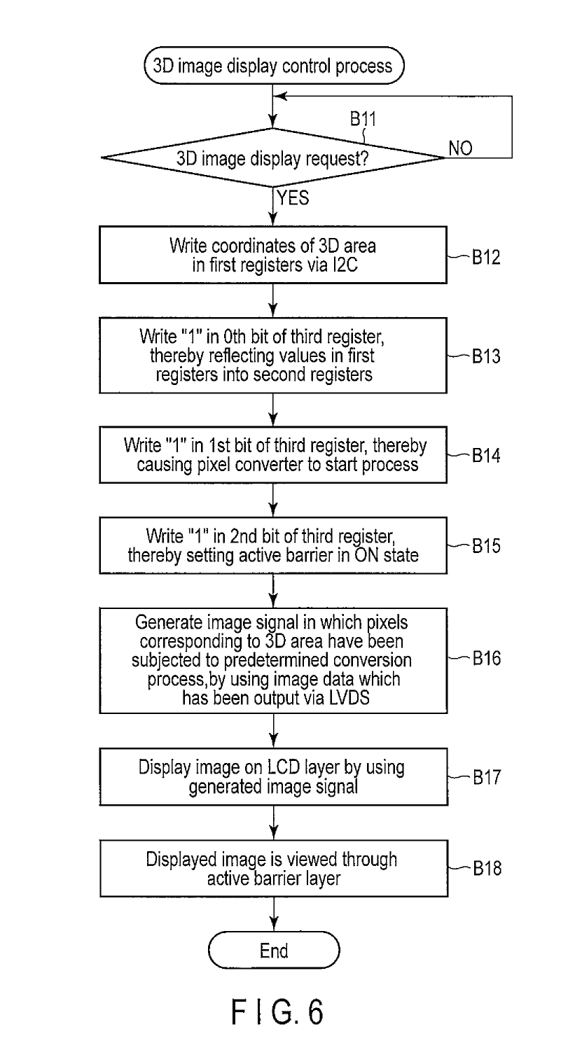

Next, referring to a flowchart of FIG. 6, a description is given of an example of the procedure of a three-dimensional (3D) image display control process which is executed by the electronic apparatus 1.

To start with, the register controller 332 of the display driver 33 determines whether display of a 3D image has been requested by the OS 31 (by the application 32 via the OS 31) (block B11). When display of a 3D image has not been requested (NO in block B11), the process returns to block B11, and the register controller 332 determines once again whether display of a 3D image has been requested.

On the other hand, when display of a 3D image has been requested (YES in block B11), the register controller 332 writes the coordinates indicative of the area (3D area) 62, which displays a 3D image, in the first registers 51 provided in the timing controller 171 via the I2C 42 (block B12).

After the process of writing the coordinates indicative of the 3D area 62 in the first registers 51 has been completed, the register controller 332 writes “1” in the 0th bit of the third register 53, thereby reflecting (copying) the values written in the first registers 51 into the second registers 52 (block B13). In addition, the register controller 332 writes “1” in the first bit of the third register 53, thereby causing the pixel converter 54 to start operation (block B14). Furthermore, the register controller 332 writes “1” in the second bit of the third register 53, thereby setting the active barrier 17B in the ON state (block B15).

Then, using display image data which has been output via the LVDS 41, the pixel converter 54 (rearrangement module 56) generates an image signal in which the pixels corresponding to the 3D area 62 have been subjected to a predetermined conversion process (block B16). Subsequently, using the generated image signal, the LCD driver 172 displays an image on the LCD layer 17A (block B17).

By viewing the image displayed on the LCD layer 17A through the active barrier layer 17B, the user can view a 3D image of the 3D area 62 and a 2D image of the 2D area 61 (block B18).

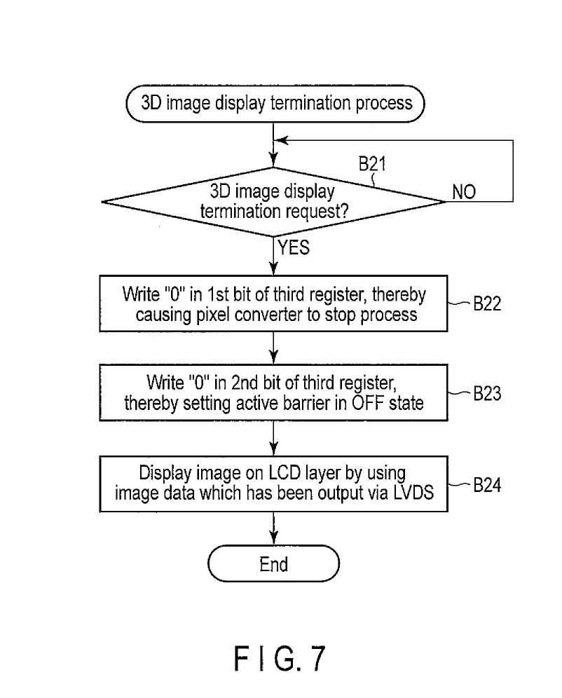

FIG. 7 is a flowchart illustrating an example of the procedure of a 3D image display termination process which is executed by the electronic apparatus 1.

To start with, the register controller 332 of the display driver 33 determines whether termination of the display of a 3D image has been requested by the OS 31 (by the application 32 via the OS 31) (block B21). When termination of the display of a 3D image has not been requested (NO in block B21), the process returns to block B21, and the display driver 33 determines once again whether termination of the display of a 3D image has been requested.

On the other hand, when termination of the display of a 3D image has been requested (YES in block B21), the register controller 332 writes “0” in the first bit of the third register 53, thereby causing the pixel converter 54 to stop the process (block B22). In addition, the register controller 332 writes “0” in the second bit of the third register, thereby setting the active barrier 17B in the OFF state (block B23). Since the display image data, which has been output via the LVDS 41, is bypassed through the pixel converter 54, the LCD driver 172 displays an image on the LCD layer 17A by using the bypassed display image data (block B24). By viewing the image displayed on the LCD layer 17A, the user can view a 2D image.

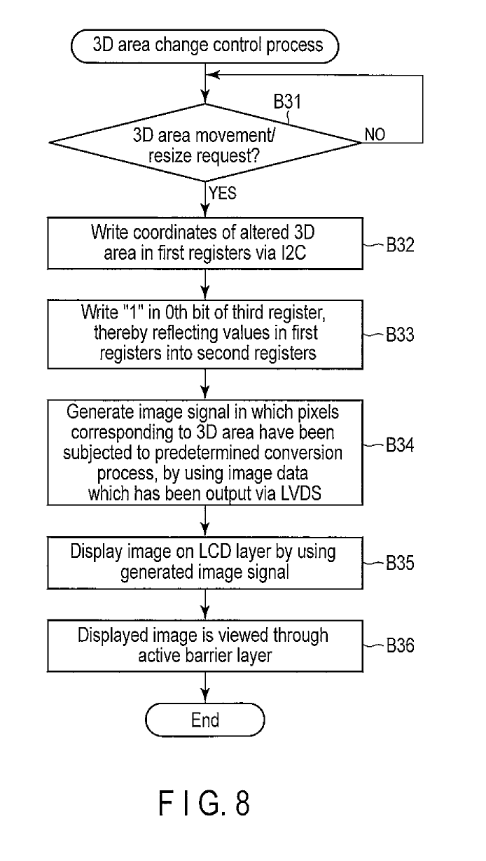

Next, referring to a flowchart of FIG. 8, the procedure of a 3D area change control process is described.

To start with, the register controller 332 of the display driver 33 determines whether an alteration of the 3D area 62 has been requested by the OS 31 (by the application 32 via the OS 31) (block B31). The request for an alteration of the 3D area 62 includes, for instance, a request for moving the 3D area 62, or a request for varying the size of the 3D area 62. When an alteration of the 3D area 62 has not been requested (NO in block B31), the process returns to block B31, and the display driver 33 determines once again whether an alteration of the 3D area 62 has been requested.

On the other hand, when an alteration of the 3D area 62 has been requested (YES in block B31), the register controller 332 writes the coordinates indicative of the varied 3D area 62 in the first registers 51 provided in the timing controller 171 via the I2C 42 (block B32).

After the process of writing the coordinates indicative of the altered 3D area 62 has been completed, the register controller 332 writes “1” in the 0th bit of the third register 53, thereby reflecting (copying) the values written in the first registers 51 into the second registers 52 (block B33). Then, using display image data which has been output via the LVDS 41, the pixel converter 54 (rearrangement module 56) generates an image signal in which the pixels corresponding to the 3D area 62 have been subjected to a predetermined conversion process (block B34). Subsequently, using the generated image signal, the LCD driver 172 displays an image on the LCD layer 17A (block B35).

By viewing the displayed image through the active barrier layer 17B, the user can view a 3D image of the 3D area 62 and a 2D image of the 2D area 61 (block B36).

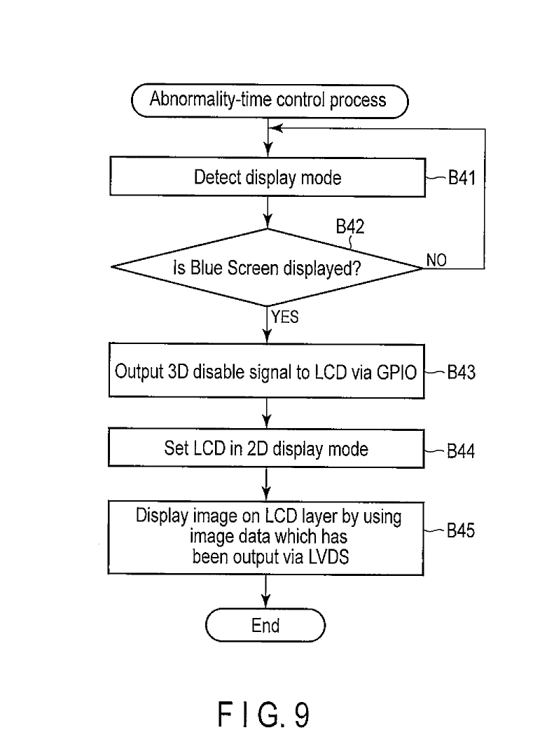

FIG. 9 is a flowchart illustrating an example of the procedure of an abnormality-time control process which is executed by the electronic apparatus 1.

To start with, the display mode detector 341 of the system BIOS 34 detects the display mode of the display unit 17 (block B41). Based on the detected display mode, the display mode detector 341 determines whether a screen that is displayed at a time of abnormality in operation of the OS 31, such as a Blue Screen of the Windows, is displayed or not (block B42). When the screen that is displayed at a time of abnormality in operation of the OS 31 is not displayed (NO in block B42), the process returns to block B41.

On the other hand, when the screen that is displayed at a time of abnormality in operation of the OS 31 is displayed (YES in block B42), the 3D controller 342 outputs the 3D disable signal to the display unit 17 via the GPIO 43 (block B43). The 3D display function of the display unit 17 is reset, responding to the 3D disable signal, and the display unit 17 is set in the 2D display mode (block B44). To be more specific, for example, the values set in the registers 51, 52 and 53 are cleared (zero clear) in accordance with the 3D disable signal, and thereby the pixel converter 54 is stopped and the active barrier 17B is set in the OFF state. Since the display image data, which has been output via the LVDS 41, is bypassed through the pixel converter 54, the LCD driver 172 displays an image on the LCD layer 17A by using the bypassed display image data (block B45). By viewing the image displayed on the LCD layer 17A, the user can view a 2D image.

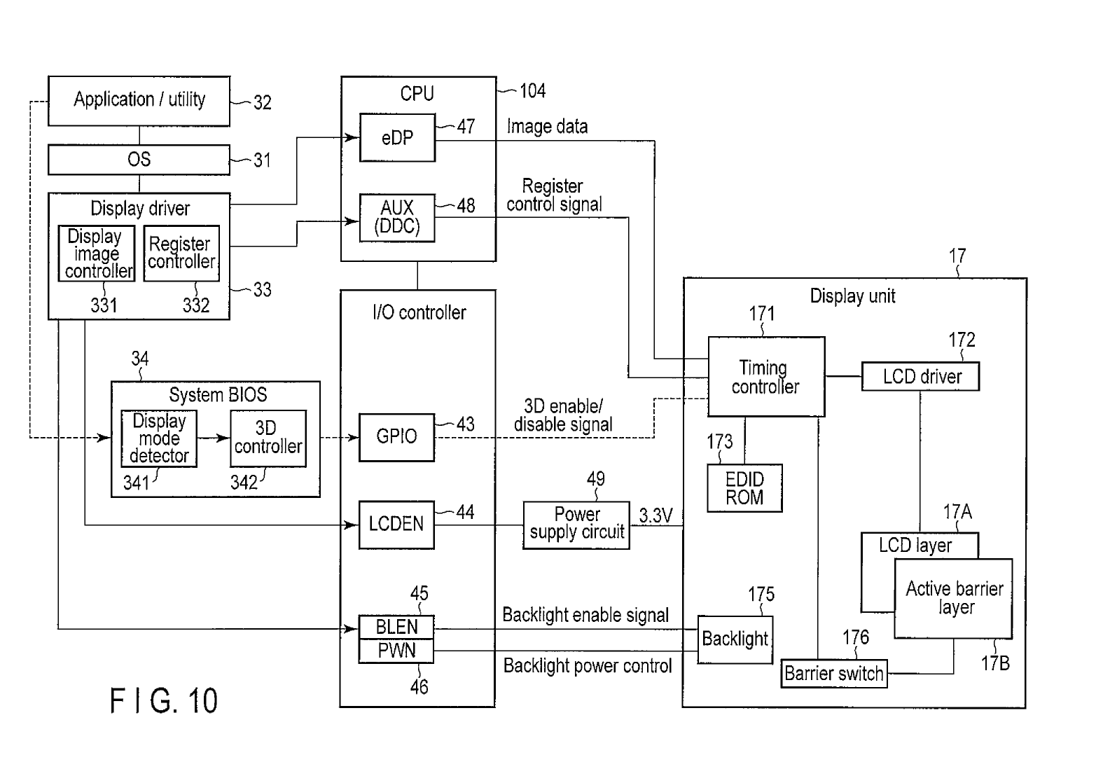

Next, FIG. 10 shows another example of the structure of the computer 1. In the structure shown in FIG. 10, the LVDS 41, which is provided in the I/O controller 104 in FIG. 4, is replaced with an embedded display port (eDP) interface 47 which is provided in a CPU 101. In addition, the I2C 42, which is provided in the I/O controller 104 in FIG. 4, is replaced with a display port auxiliary channel (AUX) 48 for a display data channel (DDC) which is provided in the CPU 101. The eDP 47 and AUX 48 have functions similar to the functions of the LVDS 41 and I2C 42, respectively. The embedded display port (eDP) and display port auxiliary channel (AUX) are defined as standards relating to the connection of displays, which are standardized by the video electronics standards association (VESA). In addition, since the communication speed (signal input/output) via the AUX 48 is higher than the communication speed via the I2C 42, values can be written more quickly in the first registers 51 in the timing controller 171. Thus, the timing controller 17 may set the 3D area 62 by referring to the first registers 51, without providing the second registers 52 as shadow registers. With the structure shown in FIG. 10, the same display control function as illustrated in FIG. 4 can be realized. Therefore, even at the time of operational abnormality of the OS 31, it is possible to properly display a screen of a 2D image which notifies the operational abnormality.

As has been described above, according to the present embodiment, at the time of operational abnormality of the operating system 31, a 2D image can properly be displayed on the display unit 17 which can display a 3D image. In the display unit 17, the 3D area 62 which displays a 3D image and the 2D area which displays a 2D image can be set on the screen. The register controller 332 outputs the coordinates indicative of the 3D area 62 to the display unit 17 via the I2C (first interface) 42. Thereby, the register controller 332 causes the display unit 17 to set the area indicated by these coordinates to be the 3D area 62, and to set the area excluding the 3D area 62 to be the 2D area 61. In addition, a video signal including a video signal for displaying a 2D image and a video signal for displaying a 3D image is output to the display unit 17 via the LVDS (second interface), thereby causing the display unit 17 to display a 2D image in the 2D area 61 and a 3D image in the 3D area 62. Then, when abnormality occurs in the operation of the OS 31 which is executed on the computer 1, a control signal (3D disable signal) for disabling the function of displaying a 3D image is output to the display unit 17 via the GPIO (third interface) 43, and thereby the entire screen of the display unit 17 is set to be the 2D area 61. Thus, it is possible to properly display, at a time of operational abnormality of the OS 31, a screen of a 2D image which notifies information relating to the current state of the OS 31 and information for dealing with the current state of the OS 31.

All the process procedures of the embodiment, which have been described with reference to the flowcharts of FIGS. 6 to 9, may be executed by software. Thus, the same advantageous effects as with the embodiment can easily be obtained simply by installing a program, which executes the process procedures, into an ordinary computer through a computer-readable storage medium which stores the program, and executing this program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus connected to a display capable of displaying a three-dimensional image, the apparatus comprising:
an area setting module configured to output a request for displaying the three-dimensional image to the display via a first interface in order to cause the display to set a three-dimensional area which displays the three-dimensional image;
a display controller configured to output a video signal for displaying the three-dimensional image to the display via a second interface in order to cause the display to display the three-dimensional image in the three-dimensional area; and
a three-dimensional function controller configured to output, when an abnormality occurs in operation of an operating system executed on the electronic apparatus, a control signal for disabling a function of displaying the three-dimensional image to the display via a third interface in order to set an entire screen of the display to be a two-dimensional area which displays a two-dimensional image.

2. The electronic apparatus of claim 1, wherein the first interface comprises an inter-integrated circuit (I2C) for a display data channel.

3. The electronic apparatus of claim 1, wherein the first interface comprises a display port auxiliary channel for a display data channel.

4. The electronic apparatus of claim 1, wherein the request comprises coordinates indicative of the three-dimensional area, and
the area setting module is configured to cause the display to set the three-dimensional area based on the coordinates.

5. The electronic apparatus of claim 4, wherein the display comprises first registers, second registers, and a third register, and
the area setting module is configured to write the coordinates indicative of the three-dimensional area in the first registers via the first interface, and to write, in response to completion of the write of the coordinates, a first value in the third register via the first interface in order to copy the coordinates written in the first registers into the second registers, thereby causing the display to set the three-dimensional area based on the coordinates copied in the second registers.

6. The electronic apparatus of claim 1, wherein the three-dimensional function controller is configured to output the control signal for disabling the function of displaying the three-dimensional image to the display via the third interface, when the three-dimensional function controller has detected that a screen for notifying an abnormality in operation of the operating system is displayed on the display.

7. The electronic apparatus of claim 1, wherein the three-dimensional function controller is configured to output the control signal for disabling the function of displaying the three-dimensional image to the display, in response to pressing of a first button provided on the electronic apparatus for a first period or more.

8. The electronic apparatus of claim 1, wherein the display is built in the electronic apparatus.

9. The electronic apparatus of claim 1, wherein the display comprises a display layer on which an image is displayed, and a barrier layer comprising a plurality of barriers for emitting, in first directions, a plurality of light rays corresponding to a plurality of pixels in the image, and
the display is configured to electrically switch on the plurality of barriers in order to set the three-dimensional area.

10. A display capable of displaying a three-dimensional image, comprising:
an area setting module configured to receive a request for displaying the three-dimensional image from an electronic apparatus via a first interface and to set a three-dimensional area which displays the three-dimensional image;
a display controller configured to receive a video signal for displaying the three-dimensional image from the electronic apparatus via a second interface and to display the three-dimensional image in the three-dimensional area; and
a three-dimensional function controller configured to set an entire screen of the display to be a two-dimensional area which displays a two-dimensional image, upon receiving a control signal for disabling a function of displaying the three-dimensional image from the electronic apparatus via a third interface.

11. The display of claim 10, wherein the first interface comprises an inter-integrated circuit (I2C) for a display data channel.

12. The display of claim 10, wherein the request comprises coordinates indicative of the three-dimensional area, and
the area setting module is configured to set the three-dimensional area based on the coordinates.

13. The display of claim 12, further comprising first registers, second registers, and a third register, and
the area setting module is configured to copy, in response to completion of write of a first value in the third register after completion of write of coordinates indicative of the three-dimensional area in the first registers via the first interface, the coordinates written in the first registers into the second registers, and to set the three-dimensional area, based on the coordinates copied in the second registers.

14. A display control method of controlling an electronic apparatus connected to a display capable of displaying a three-dimensional image, the method comprising:
outputting a request for displaying the three-dimensional image to the display via a first interface in order to cause the display to set a three-dimensional area which displays the three-dimensional image;
outputting a video signal for displaying the three-dimensional image to the display via a second interface in order to cause the display to display the three-dimensional image in the three-dimensional area; and
outputting, when an abnormality occurs in operation of an operating system executed on the electronic apparatus, a control signal for disabling a function of displaying the three-dimensional image to the display via a third interface in order to set an entire screen of the display to be a two-dimensional area which displays a two-dimensional image.
